(19) United States
(12) Patent Application Publication
(10) Pub. No.: US 2008/0055781 A1
(43) Pub. Date: Mar. 6, 2008

(54) Reverse touch lapping process for sliders

(75) Inventors: Khanna Arun, Hong Kong (CN); Gascon Abraham, Hong Kong (CN); Wang Quan Bao, Hong Kong (CN); Choudhury Somen, Hong Kong (HK)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd.,, Hong Kong (CN)

(21) Appl. No.: 11/511,508

(22) Filed: Aug. 29, 2006

(51) Int. Cl. G11B 21/16

(52) U.S. Cl. 360/240

(57) ABSTRACT

Systems and methods for making sliders having larger roll off shapes and smaller pole tip recessions on the overcoat areas of air bearing surfaces (ABS) are provided. In certain example embodiments, at least one row bar may be positioned on a lapping machine's mounting fixture. Each row bar may include at least one slider, and each slider may include a side having a thin-film element formed thereon. A dummy bar may be positioned on the mounting fixture such that the dummy bar is lapped before any of the row bars. Then, the mounting fixture may be used to bring the surface of each row bar into contact with the lapping table's lapping surface. The row bar may be rotationally lapped such that for each row bar, the side having the thin-film element is lapped first. Thus, sliders having small pole tip recessions and larger roll off shapes may be produced.

### FIELD OF THE INVENTION

The example embodiments herein relate to information recording disk drive devices, and, more particularly, to techniques for making a slider having a larger roll off shape and a smaller pole tip recession on the overcoat area of its air bearing surface (ABS).

### BACKGROUND OF THE INVENTION

One known type of information storage device is a disk drive device that uses magnetic media to store data and a movable read/write head that is positioned over the media to selectively read from or write to the disk.

Hard disk drives (HDDs) are being used in more and more digital devices, such as, for example, digital cameras, audio/video equipment, and even televisions, all of which may require large storage capacities. The demands from these diverse markets have spurred two research and development goals—namely, higher areal densities and smaller form factors.

Creating a higher areal density of recording media generally requires reducing the dimensions of the magnetic read/write head. However, as the size of the magnetic element becomes smaller, the read/write signal will become weaker. To compensate for the reduction in magnetic signal strength, the magnetic layer performance may be enhanced and the magnetic spacing may need to be reduced accordingly. Magnetic spacing may be reduced by tightening control of the flying height of a slider carrying the magnetic read/write head, applying a protective coating to the magnetic slider and the hard disk media, creating a slider pole tip recession (PTR), etc.

Reducing the size of the HDD is a matter of system engineering, generally requiring the changing of physical dimensions and the re-optimization of flying dynamics. However, these modifications are difficult to make, in part, because different form factor drives demand varying reliability criteria, based in part on the particular application. For example, there are important differences in reliability requirements between desktop computers, notebook computer, mobile devices including phones, digital cameras, etc.

FIGS. 1a-1b illustrate a conventional disk drive unit and show a magnetic disk 101 mounted on a spindle motor 102 for spinning the disk 101. A voice coil motor arm 104 carries a HGA 100 that includes a micro-actuator with a slider 103 incorporating a read/write head 105. A voice-coil motor (VCM) is provided for controlling the motion of the motor arm 104 and, in turn, controlling the slider 103 to move from track to track across the surface of the disk 101, thereby enabling the read/write head to read data from or write data to the disk 101. In operation, a lift force is generated by the aerodynamic interaction between the slider 103, incorporating the read/write transducer, and the spinning magnetic disk 101. The lift force is opposed by equal and opposite spring forces applied by a suspension of the HGA 100 such that a predetermined flying height above the surface of the spinning disk 101 is maintained over a full radial stroke of the motor arm 104.

The arm 104, which is installed on a base plate of the disk drive unit, rotates around a pivot hole formed in the middle of the arm. The VCM includes a coil that is coupled with the other end of the arm 104. The elements may be collectively referred to a head stack assembly (HSA). A lower yoke is installed under the coil, with the lower yoke being fixed to the base plate of the disk drive unit and spaced a predetermined distance apart from the coil. An upper yoke is installed above the coil, while a magnet is attached to the bottom surface thereof. In an alternative arrangement, the magnet also may be attached to a top surface of the lower yoke.

The VCM is controlled by a servo control system (not shown), which rotates the slider 103 of the actuator from the parking zone to the data zone when the disk drive unit is turned on, and rotates the head (attached to the slider 103) from the data zone to the parking zone when the disk drive unit is turned off.

Sliders including magnetic read/write heads are important elements of disk drive units. Conventional sliders include several parts. A first part is a ceramic housing that is capable of controlling the flying attitude of the slider, on which patterns (e.g. landing pads, flying rails, negative pressure cavities, etc.) are deposited or etched. A second part is the functional layers, which include transducers (or magnetic pole tips) and the read/write wire connecting the transducers and the pad (or the bonding pad).

Conventional lapping techniques for producing sliders are well known in the art, and include the techniques disclosed in U.S. Pat. No. 6,163,954, the entire contents of which are incorporated herein by reference. In brief, a typical slider building processes uses an ultra-fine diamond slurry having a nominal diameter of about 50 nm to 100 nm to lap the surface to achieve a very flat surface (e.g. a roughness, Ra, approximately less than 0.3 nm) on the magnetic pole tip while reducing the pole tip recession (PTR).

These conventional techniques produce sliders like the one shown schematically in FIG. 1c, which shows a simplified, conventional slider flying over media to generate a read/write signal. The slider 103 flies over the disk 101, and the read/write head 105 generates a signal. It is advantageous to keep the read/write head 105 as close to the disk 101 as possible to increase performance, for example, by allowing faster read/write times, removing interference, etc. Accordingly, pole tip 103a is only slightly recessed from the main slider element 103. Unfortunately, in trying to address the above-described problems (e.g. in trying to meet the growing demands placed on disk drive units), conventional slider arrangements actually may exacerbate the problems and/or create new problems. For example, if the slider flies to low, the trailing edge of the pole tip 103a will come into contact with the disk 101. The resulting contact may result in head-disk interface problems while transmitting the signal, it may damage the read/write head 105, the disk 101, etc.

Thus, it will be appreciated that there is a need for an improved system that does not suffer from one or more of the above-mentioned drawbacks.

### SUMMARY OF THE INVENTION

One aspect of the present invention relates to a method of producing a slider. Such example methods may comprise positioning at least one row bar on a lapping machine's mounting fixture. Each row bar may include at least one slider. Each slider, in turn, may include a side having a thin-film element formed thereon. A dummy bar may be positioned on the mounting fixture such that the dummy bar is lapped before the at least one row bar. The mounting fixture may be used to bring the surface of each row bar into contact with the lapping table's lapping surface. The at least one row bar may be rotationally lapped such that for each row bar, the side having the thin-film element is lapped first. The resulting slider's overcoat may have a small pole tip recession and a roll off shape at its edge.

Certain example embodiments may further comprise specifying at least one parameter to control a feature of the slider. The parameter may be used to control the pole tip recession's depth, the roll off shape's size, etc. In certain other example embodiments, the lapping surface may be prepared in certain ways to control a feature of the slider. According to certain example embodiments, the row bars may be rotationally lapped in a conventional direction, and each row bar may be positioned on the mounting fixture rotated 180 degrees from a conventional orientation. According to certain other example embodiments, the row bars may be rotationally lapped in a direction opposite from a conventional direction, and each row bar may be positioned on the mounting fixture in a conventional orientation.

Another aspect of the present invention relates to a slider for use in a hard disk drive having an overcoat with an air bearing surface. The overcoat may comprise a pole tip recession that includes a read/write head. The pole tip recession may be recessed a small amount from the air bearing surface, and may be located at an end of the overcoat. The overcoat may include a roll off shape at the end of the overcoat that has the pole tip recession.

Still another aspect of the present invention relates to a disk drive device. The disk drive device may comprise a head stack assembly including a head gimbal assembly having a slider with a read/write head thereon and a drive arm connected to the head gimbal assembly; a disk operable to be read from and/or written to by said read/write head; and, a spindle motor operable to spin the disk. The slider may further comprise an overcoat with an air bearing surface. The overcoat may comprise a pole tip recession that includes the read/write head. The pole tip recession may be recessed a small amount from the air bearing surface and may be located at an end of the overcoat. The overcoat may include a roll off shape at the end of the overcoat that has the pole tip recession.

In certain example embodiments, the overcoat may be formed from alumina-titanium carbide. In certain example embodiments, the roll off shape may be a curved, or substantially curved, area at the end of the overcoat that ranges from about 3 nm to 6 nm in depth. According to certain example embodiments, the roll off shape may be formed by lapping the slider, and the slider may be lapped such that the air bearing surface of the overcoat is lapped first.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1a is a perspective view of a conventional hard disk drive unit;

FIG. 1b is a partial, perspective view of the conventional disk drive unit shown in FIG. 1a;

FIG. 1c shows a conventional slider flying over media to generate a read/write signal;

FIG. 2a shows a conventional slider having a small pole tip recession;

FIG. 2b shows a slider having a small pole tip recession, with a roll off shape;

FIG. 3a shows an atomic force microscope scan for a slider produced using conventional techniques;

FIG. 3b shows an atomic force microscope scan for a slider produced in accordance with an example embodiment;

FIG. 4 shows a wafer and a slider cut out from the wafer according to a conventional slider producing method;

FIGS. 5a-5b are used to illustrate a lapping process in accordance with an example embodiment;

FIG. 6 is a plan view of the sliders mounted to the mounting surface for the lapping device in accordance with an example embodiment;

FIG. 7a shows row bars on the lapping surface of the lapping device according to a conventional lapping process;

FIG. 7b shows row bars on the lapping surface in accordance with an example embodiment;

FIG. 8a shows a side view of a single row bar on the lapping surface according to a conventional lapping process;

FIG. 8b shows a side view of a single row bar on the lapping surface in accordance with an example embodiment; and,

FIG. 9 is a flowchart of a process for producing a slider having a roll off shape and a small PTR in accordance with an example embodiment.

### DETAILED DESCRIPTION OF ILLUSTRATED EMBODIMENTS

The above-described challenges may be overcome by keeping the PTR as minimum as possible while creating a bigger recession at the trailing edge of the slider's ceramic housing or overcoat, which thereby extends the end portion of the slider to a higher clearance level above the disk. The overcoat typically is formed from an alumina (such as, for example, alumina-titanium carbide, known alternately as Al₂O₃—TiC and AlTiC). This particular overcoat shape may be referred to as a “roll off” shape. The roll off shape helps to reduce head-disk interface problems during read/write operations at normal and low pressures. Having a “roll off” shape on the trailing edge of the slider also will have the advantage of improved fly height variation and reliability. According to certain example sliders, the roll off shape may be a curved shape. By way of example and without limitation, the roll off shapes in certain example sliders may be between 3 nm and 6 nm in depth.

While conventional processes are incapable of producing this advantageous slider configuration, certain example embodiments herein relate to a process that uses existing tooling facilities to produce appropriately shaped sliders. Because these example embodiments use existing facilities, no additional investment is required. Fabricating sliders with controlled pole tip recessions and roll off shapes at the trailing edges also reduces and/or prevents electrical damage to the magnetic sliders, thus reducing and/or preventing yield losses during volume production. Thus, the example embodiments may be advantageous because they achieve advantageous controlled pole tip recessions and roll off shapes with little or no additional costs for processing and/or equipment. Moreover, little or no lead time may be required.

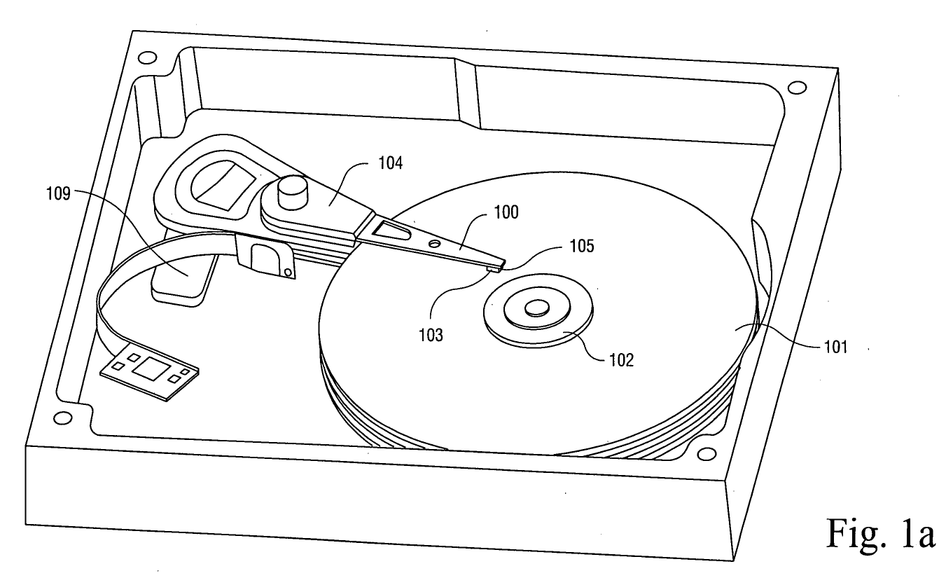

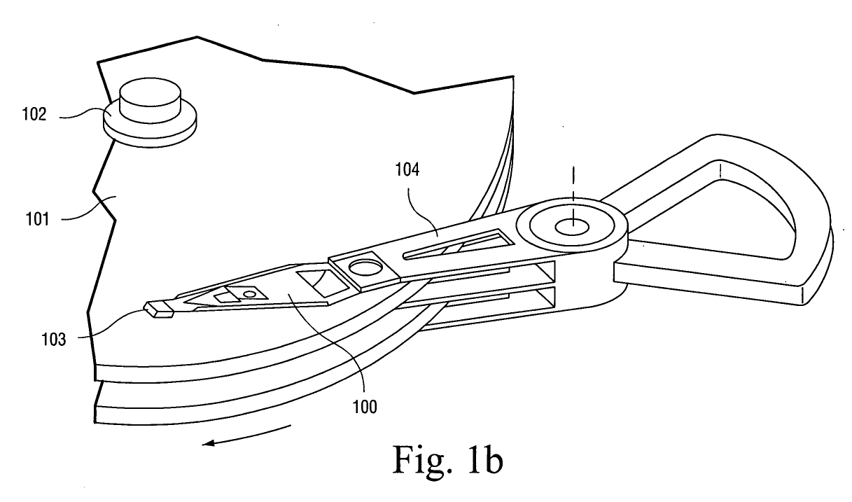

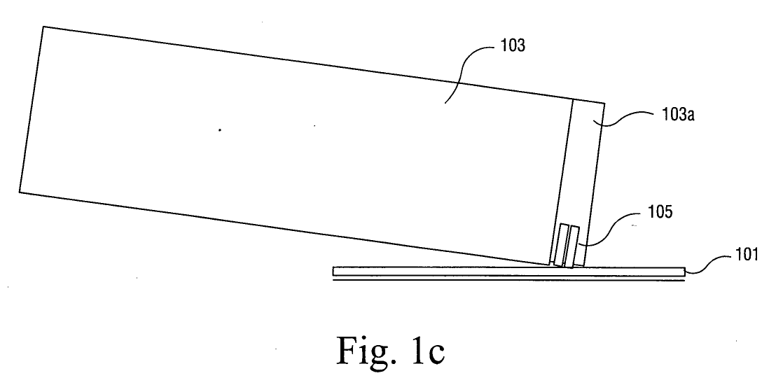

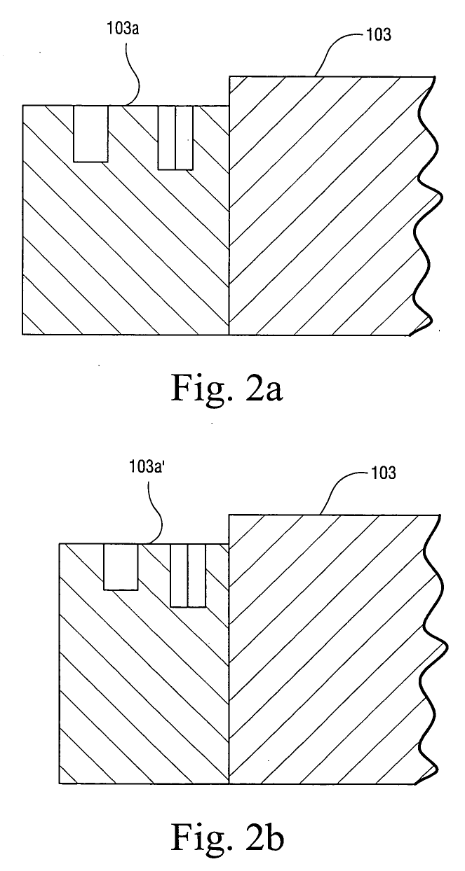

Referring now more particularly to the accompanying drawings in which like reference numerals indicate like parts throughout the several views, FIGS. 2a and 2b both show sliders with small pole tips recessions. More particularly, FIG. 2a shows a conventional pole tip, while FIG. 2b shows a pole tip with a roll off shape. As can be seen in both FIGS. 2a and 2b, the pole tips 103a and 103a ′ are recessed from the main slider portion 103. However, in FIG. 2b, the trailing edge of the pole tip 103a is formed with the advantageous roll off shape. Thus, using a slider having a roll off shape and a small pole tip recession according to an example embodiment allows the slider to fly closer to the disk while reducing (or eliminating) the problems described above with reference to FIG. 1c (e.g. contact between the slider and the disk, damage to the respective parts, etc.). It will be appreciated that FIGS. 2a and 2b are not shown to scale.

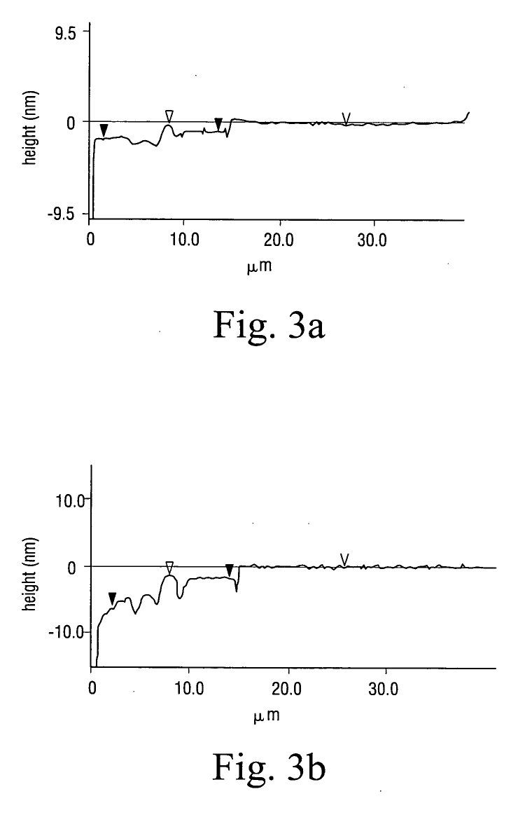

FIGS. 3a and 3b both show atomic force microscope scans of the ends of sliders, including the pole tips. More particularly, FIG. 3a shows an AFM scan for a slider produced using conventional techniques, while FIG. 3b shows an AFM scan for a slider produced in accordance with an example embodiment described herein. The scans were taken with the sliders oriented as shown in FIGS. 2a and 2b, respectively. Both figures plot the amount of recession (or height) versus the length of the slider, thus showing the amount of recession relative to the slider. It will be appreciated that although the location of the pole tip relative to the slider is described herein as a recession, the invention should not be considered in such a limited fashion. For example, the slider may be thought of as protruding from, or extending above, the pole tip. It also will be appreciated that the variation in the shapes of the sliders are produced as a product of the lapping process, although, as noted above, the surface roughness is very small. Thus, when assessing the variation shown, the high resolution of the AFM scan will be noted.

As can be seen from FIG. 3a, the pole tip recession 103a does not deviate very far from the rest of the slider 103. While this configuration is good, for example, for read/write performance, it may lead to the drawbacks described above with reference to FIG. 1c. However, as can be seen from FIG. 3b, a slider produced according to an example embodiment will have a curved end portion at the trailing edge of the slider, reflecting the more advantageous roll off shape while also allowing the pole tip recession to remain small to allow, for example, for good read/write performance. It will be appreciated that a roll off shape alone may not be advantageous, because recessing the read/write head too far may result in, for example, declined performance. Thus, it will be appreciated that certain example embodiments maintain a small pole tip recession while also providing a roll off shape at the end which does not greatly alter the location of the read/write head.

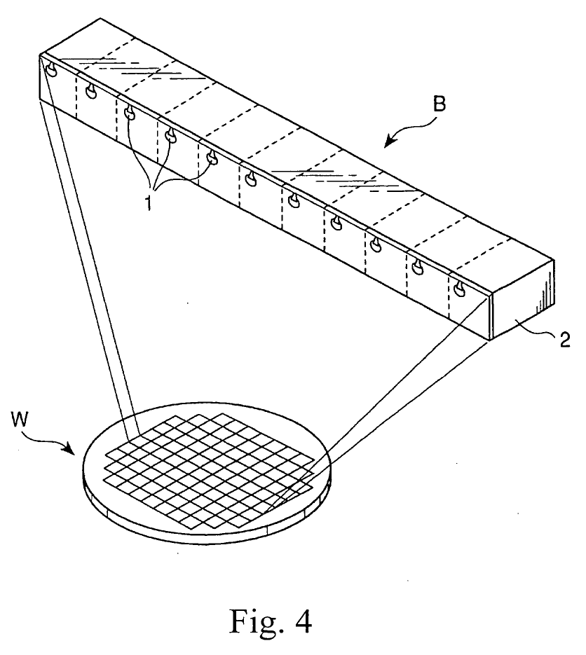

FIG. 4 shows a wafer and a slider cut out from the wafer according to a conventional slider producing method. In FIG. 4, a row of a read/write (reproducing/recording) thin-film elements are formed in a pattern on a round shaped wafer W formed of, for example, alumina-titanium carbide (Al₂O₃—TiC) ceramic. Each thin-film element 1 comprises a read (reproducing) head, for reproducing magnetic signals recorded on a magnetic recording medium, and a write (recording) head, for recording magnetic signals on a magnetic recording medium (e.g. a disk). Each read head comprises a magnetoresistive (MR) head portion formed by a magnetoresistive effect element portion. Each recording head has an inductive head portion 1b formed of a coil and a core, which are formed into a pattern.

Some of thin-film elements arranged in rows are cut out from the wafer W to produce slider bars (or row bars) B. When separating the row bars (e.g. cutting the row bars B from wafer W), an end portion (or a magnetic gap portion) of the MR head portion and the inductive head portion of each of the thin-film elements 1 are exposed at the sectioned surface of the corresponding row bar B.

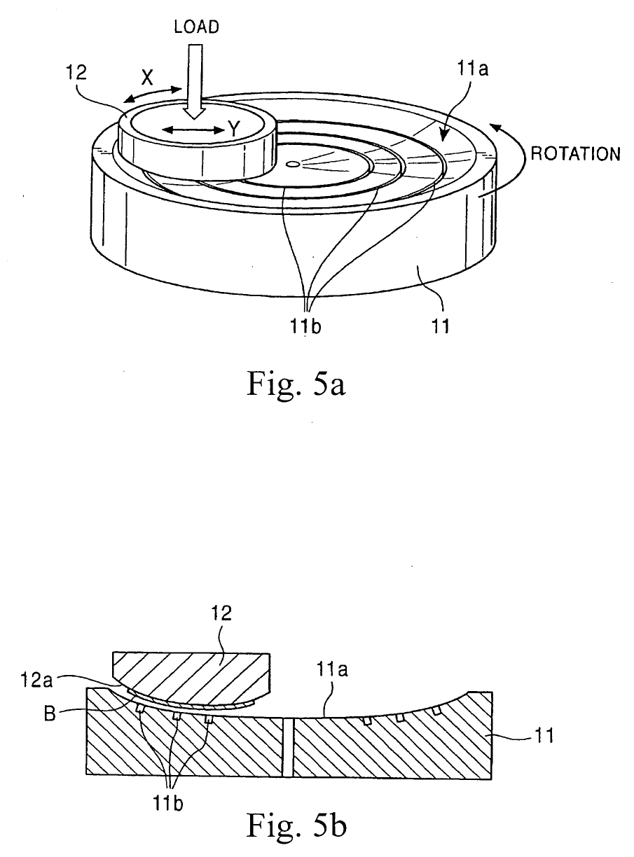

With the row bars thus formed, the surface of each row bar B where the magnetic gap portions of each thin-film element 1 are exposed is lapped. The lapping process is described with reference to FIGS. 5a and 5b. A lapping table 11, capable of rotation, is the main part of a lapping machine. A lapping plate is mounted on the lapping table 11. The lapping plate is prepared by a series of processes in which diamond particles are embedded in the lapping surface 11a (e.g. the surface that will come into contact with the row bar).

A mounting fixture (or holder) 12 to which the row bars are attached is disposed over the lapping surface 11a. In particular, the row bars are mounted parallel to each other on the mounting fixture 12 with adhesive material applied to the mounting surface 12a, as shown in the FIG. 5b. The row bars should be mounted such that surfaces with the thin-film elements 1 are exposed to the plate surface. A load (e.g. a load having a weight of 2 kg) is applied onto the mounting fixture 12 from above, pressing the row bars attached to the mounting surface 12a of the mounting fixture 12 against the lapping surface 11a. Thus, when the lapping plate rotates, the row bar surface will be formed with the material lapped away. It will be appreciated that the row bars may be attached to the removably attached to the lapping surface 11a with other materials and in other configurations. In an example embodiment, a row bar sufficient to produce only two sliders may be so mounted, whereas other example embodiments may lap multiple row bars at a time, each row bar potentially capable of producing multiple sliders.

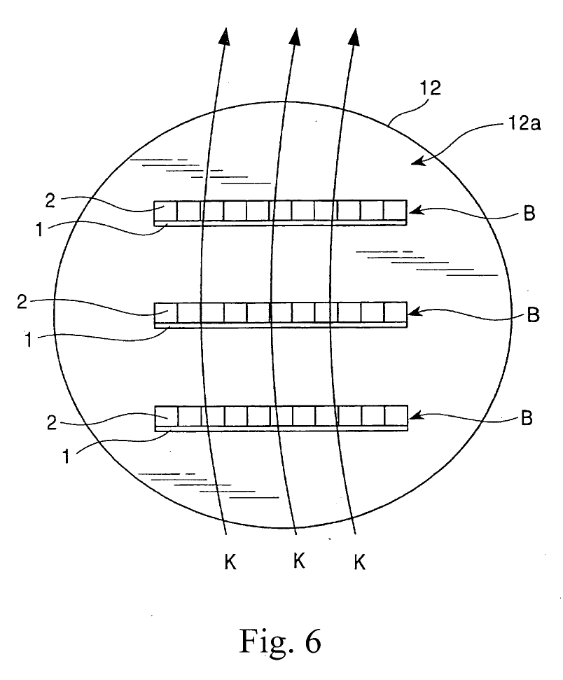

To obtain the roll off shape on each row bar, the side of the slider with the thin-film elements (the trialing edge) of the alumina needs to be lapped first (e.g. the trailing edge of the alumina should be the first surface to contact the lapping plate at any point), unlike conventional lapping processes. FIG. 6 is a plan view of the sliders mounted to the mounting surface in accordance with an example embodiment. The arrows in FIG. 6 indicate the reversed lapping direction.

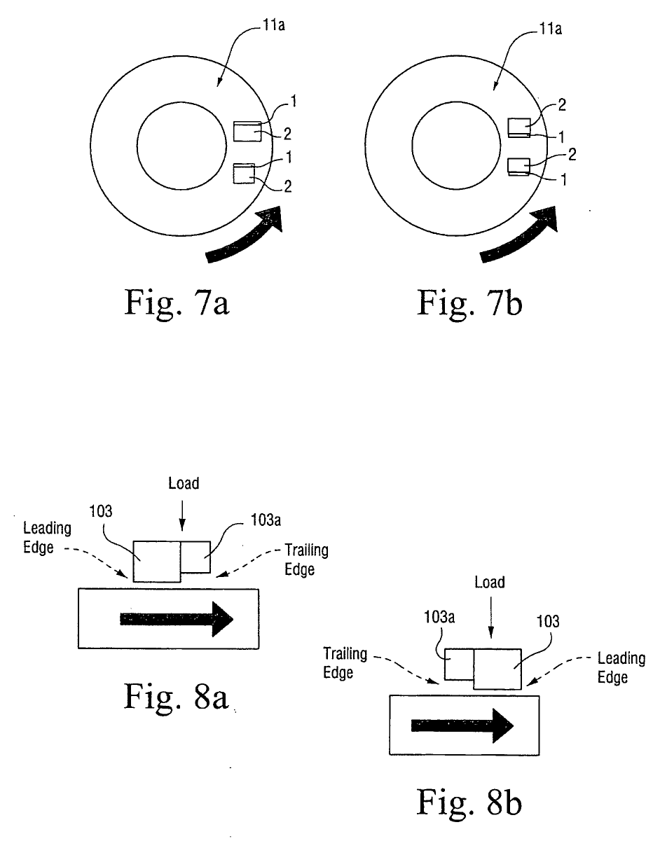

FIGS. 7a and 7b respectively show row bars on the lapping surface 11a, according to a conventional lapping process and according to a lapping process in accordance with an example embodiment. In both figures, the large arrows show the rotational directions. As can be seen in FIGS. 7a and 7b, the side with the thin-film element is lapped second according to the conventional process, while it is lapped first according to an example embodiment.

Similarly, FIGS. 8a and 8b respectively show side views of a single row bar on the lapping surface, according to a conventional lapping process and according to a lapping process in accordance with an example embodiment. In both figures, the large arrows show the rotational directions. As can be seen in FIGS. 8a and 8b, the side with the thin-film element is lapped second according to the conventional process, while it is lapped first according to an example embodiment. Differently stated, the leading edge is lapped first and the trailing edge is lapped second in the conventional process shown in FIG. 8a, whereas the trailing edge is lapped first and the leading edge is lapped second in a process according to an example embodiment

Unfortunately, merely reversing the orientation of the direction of the row bars may present problems. For example, the recess relative to the base of the alumina may be formed too deep. Thus, the thin-film element 1 may be located too far from the disk when the slider ultimately is located in a disk drive unit. Also, the lapped out material may float around (e.g. as particles) and thus may become embedded in, or result in damage to, the soft material comprising the thin-film element 1. For example, this may result in electrical damage to and/or degradation of the electrical performance of the slider.

To overcome these problems, a dummy bar may be positioned in front of the row bars to be lapped. This will clean out the diamond slurry and filter the particles, thus helping to prevent scratches, smears, and/or other potentially damaging effects. Also, the use of the dummy bar in the front of row bars to be lapped also helps to maintain a good uniformity of the roll off shapes. Accordingly, by lapping the slider bars B from the side of their corresponding base portions from the trialing side to the leading side, it is possible to form a roll off shape.

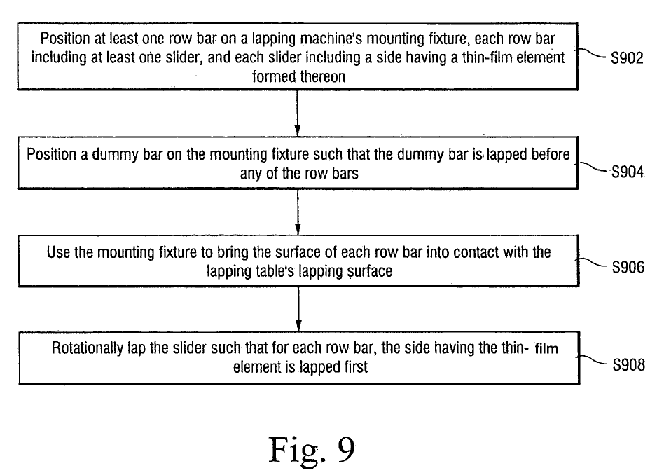

FIG. 9 is a flowchart of a process for producing a slider in accordance with an example embodiment. In step S902, at least one row bar is positioned on a lapping machine's mounting fixture. Each row bar may include at least one slider, and each slider may include a side having a thin-film element formed thereon. In step S904, a dummy bar is positioned on the mounting fixture such that the dummy bar is lapped before any of the row bars. Then, the mounting fixture is used to bring the surface of each row bar into contact with the lapping table's lapping surface in step S906. The row bar is rotationally lapped such that for each row bar, the side having the thin-film element is lapped first in step S908. Thus, this example process may be used to produce sliders having small pole tip recessions and roll off shapes.

In accordance with another example embodiment, an alternate lapping machine and method may be used to produce a slider having a small pole tip recession and a roll off shape. For example, a lapping machine allowing movement only across a Z-axis (as compared to allowing movement across the X- and Y-axes as shown in FIG. 5a) may be used.

In accordance with yet another example embodiment, sliders having small pole recessions and roll off shapes may be produced by locating row bars in the conventional orientations, while reversing the lapping direction (e.g. from clockwise to counterclockwise, or vise versa, as required by the particular embodiment). In such example embodiments, if a dummy bar is used, it may be placed on the opposite side of the row bars to compensate for the debris being generated from the other side as compared with the example embodiments described above (e.g. those that use the same rotational direction but reverse the orientation of the row bars).

Various parameters may be specified to cause the exemplary illustrative embodiments to vary the sliders produced. For example, the lapping plate may be modified. Modifications may include, for example, changing the slurry diamond particle size distribution for plate charging, change the land-to-groove ratio for the plate, plate hardness, etc. It will be appreciated that different plate conditioning may be used depending on the characteristics of the resulting slider desired. For example, it may be possible to change PTR and roll off shape with various plate conditioning parameters. PTR and roll off shape also may be changed through process parameter optimization. However, it will be appreciated that process parameter optimization similarly is highly dependent on the exact nature of the product desired. For example, while the smallest acceptable PTR is ZERO PTR, the size of the PTR is very product specific, as the ABS design and the pitch may help determine the minimum clearance point.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A method of producing a slider, the method comprising:
positioning at least one row bar on a lapping machine's mounting fixture, each row bar including at least one slider, and each slider including a side having a thin-film element formed thereon;
positioning a dummy bar on the mounting fixture such that the dummy bar is lapped before the at least one row bar;
using the mounting fixture to bring the surface of each row bar into contact with the lapping table's lapping surface; and,
rotationally lapping the at least one row bar such that for each row bar, the side having the thin-film element is lapped first;
wherein the slider has an overcoat with a small pole tip recession, and further wherein the overcoat is formed with a roll off shape at its edge.

2. The method of claim 1, further comprising specifying at least one parameter to control a feature of the slider.

3. The method of claim 2, wherein the at least one parameter is used to control at least one of the pole tip recession's depth or the roll off shape's size.

4. The method of claim 1, further comprising preparing the lapping surface to control a feature of the slider.

5. The method of claim 1, wherein the overcoat is formed from alumina-titanium carbide.

6. The method of claim 1, wherein the row bars are rotationally lapped in a conventional direction, and further wherein each row bar is positioned on the mounting fixture is rotated 180 degrees from a conventional orientation.

7. The method of claim 1, wherein the row bars are rotationally lapped in a direction opposite from a conventional direction, and further wherein each row bar is positioned on the mounting fixture in a conventional orientation.

8. A slider for use in a hard disk drive having an overcoat with an air bearing surface;
the overcoat comprising a pole tip recession that includes a read/write head;
the pole tip recession being recessed a small amount from the air bearing surface and being located at an end of the overcoat; and,
the overcoat further including a roll off shape at the end of the overcoat that has the pole tip recession.

9. The slider of claim 8, wherein the overcoat is formed from alumina-titanium carbide.

10. The slider of claim 8, wherein the roll off shape is a curved, or substantially curved, area at the end of the overcoat that ranges from about 3 nm to 6 nm in depth.

11. The slider of claim 8, wherein the roll off shape is formed by lapping the slider.

12. The slider of claim 11, wherein the slider is lapped such that the air bearing surface of the overcoat is lapped first.

13. A disk drive device, comprising:
a head stack assembly including a head gimbal assembly having a slider with a read/write head thereon and a drive arm connected to the head gimbal assembly;
a disk operable to be read from and/or written to by said read/write head; and,
a spindle motor operable to spin the disk;
wherein said slider further comprises:
an overcoat with an air bearing surface, the overcoat comprising a pole tip recession that includes the read/write head, the pole tip recession being recessed a small amount from the air bearing surface and being located at an end of the overcoat; and, the overcoat further including a roll off shape at the end of the overcoat that has the pole tip recession.

14. The disk drive device of claim 13, wherein the overcoat is formed from alumina-titanium carbide.

15. The disk drive device of claim 13, wherein the roll off shape is a curved, or substantially curved, area at the end of the overcoat that ranges from about 3 nm to 6 nm in depth.

16. The disk drive device of claim 13, wherein the roll off shape is formed by lapping the slider.

17. The disk drive device of claim 16, wherein the slider is lapped such that the air bearing surface of the overcoat is lapped first.
